(19) United States
(12) Patent Application Publication
(10) Pub. No.: US 2005/0198043 A1
(43) Pub. Date: Sep. 8, 2005

(54) Database masking and privilege for organizations

(76) Inventors: Harry E. Gruber, Rancho Santa Fe, CA (US); Jeane Chen, Del Mar, CA (US); Allen B. Gruber, San Antonio, TX (US)

Correspondence Address: Michael A. Rahman;DORSEY & WHITNEY LLP, Suite 3400, 1420 Fifth Avenue, Seattle, WA, 98101, US

(21) Appl. No.: 10/439,899

(22) Filed: May 15, 2003

(51) Int. Cl. G06F 7/00

(52) U.S. Cl. 707/100

(57) ABSTRACT

A database in a computer system linked to a network is discloses. The database is configured to store one or more organizations' data. Each organization comprises one or more sub-organizations. The database is partitioned into one or more virtual data islands, wherein each virtual data island stores data of an organization. Each virtual data island is further partitioned into one or more sub-islands, wherein each sub-island stores data for a sub-organization. There are one or more constituent records (CR) in each sub-island, each CR including one or more fields with data. A sub-organization can share data from selected fields with multi-level organizations and other sub-organizations. The database further comprises a masking means allowing the sub-organization, individual donors or volunteers to mask one or more fields in the CR, wherein data in the masked fields are not shared with organizations and other sub-organizations. The CR includes donor information, including donor names, addresses, amount of money donated, etc. The invention allows individual donors and/or the organizations to mask selected fields.

### BACKGROUND

1. Field of Invention

The present invention relates to a shared database system. More specifically, the invention relates to a virtual database shared by multiple organizations that allow organizations to mask certain data.

2. Related Art

Multi-level organizations typically have a national organization and various local chapters. For example, a multi-level nonprofit organization (NPO) typically includes a national organization, several regional chapters and many local chapters. A multi-level organization can be a membership organization, charitable, philanthropic, religious or political organization.

Multi-level organizations such as NPOs and their regional and local chapters often engage in fundraising activities. Charitable and other NPOs often raise money through fundraising. These organizations utilize various well-known methods to establish contact with potential donors that often lead a potential donor to make a contribution to the organizations. Common fundraising schemes include live events, mail campaigns, emails, and telephone calls.

Whether an NPO is engaged in fundraising activities or is merely an association, it typically has a large number of members or donors. During its normal course of business, the NPO acquires information about its members, donors, potential donors and supporters. The information may include member or donor names, addresses and other contact information, transactional information such as amount of money donated, and financial information such as income. It is necessary for the NPO to retain the information including individual data efficiently.

NPOs often utilize a database management system to store individual records. A database management system application may comprise a database server and several client or organization systems. The database is housed in the database server, together with various applications for manipulating the data in the database. In a typical database management system, the individual records are stored in tables. Each table identifies fields, or columns, and individual records are stored as rows, with a data entry in each column. For example, in a donor database, there may be a table DONOR which comprises fields, or columns, such as donor ID, last name, first name, address, city, state, donation amount, and so forth.

Establishing privacy in databases in critical to multi-level organizations and their chapters. Establishing a common platform is also desirable because that allows multiple chapters to use the database. In some cases, it is often desirable to share information among various organizations whose databases are hosted in one large data-warehouse. It is further desirable that the sharing of such information be compliant with the organization's wishes of what type of information is shared and with whom it is shared.

It is further desirable that the organizations or specific individuals within an organization have some convenient way of controlling the conditions under which their data can be used either for sharing or to generate metadata for sharing. It is also sometimes desirable that the individuals own the information comprising the data in a data warehouse have the ability to designate whether or not their data should be part of a data-sharing mechanism as indicated above.

For example, a multi-level NPO may prefer to store its records and the records of its chapters in one database management system that would allow them to share certain information among themselves. The chapters, however, may desire to mask certain information from being shared.

Furthermore, for reasons of efficiency and economy of scale, an applications service provider (ASP) may prefer to store records of a plurality of organizations such as NPOs in a single database system. It would also allow the chapters in a multi-level organization to share selected data, and it would also allow different organization to share selected data if they desire.

### SUMMARY OF THE INVENTION

The invention is directed to a database in a computer system linked to a network. The database is configured to store one or more organizations' data. Each organization comprises one or more sub-organizations. The database is partitioned into one or more virtual data islands, wherein each virtual data island stores data of an organization. Each virtual data island is further partitioned into one or more sub-islands, wherein each sub-island stores data for a sub-organization. There are one or more constituent records (CR) in each sub-island, each CR including one or more fields with data. A sub-organization can share data from selected fields with multi-level organizations and other sub-organizations.

The database further comprises a masking means allowing the sub-organization, individual donors or volunteers to mask one or more fields in the CR, wherein data in the masked fields are not shared with organizations and other sub-organizations. The CR includes donor information, including donor names, addresses, amount of money donated, etc. The invention allows individual donors and/or the organizations to mask selected fields.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 illustrates a database in accordance with one embodiment of the invention.

FIG. 2 illustrates a sub-island.

FIG. 3 illustrates a record that retains information about a particular member of the sub-organization.

FIG. 4 illustrates masked fields.

FIG. 5 illustrates another embodiment of the invention.

### DETAILED DESCRIPTION OF THE INVENTION

The present invention provides a solution to the above-mentioned problems using a novel database structure. Briefly stated, the invention provides a database structure, referred herein as the data warehouse, which hosts databases of one or more organizations. The organizations can be multi-level organizations, each multi-level organization comprising one or more sub-organizations.

The invention allows sharing of proprietary information among various sub-organizations and organizations participating in the data warehouse. The data warehouse can be maintained and managed by an Application Service Provider (ASP) or any other organization for the benefit of one or more organizations.

In one embodiment, the multi-level organizations are nonprofit organizations (NPOs) such as charitable, philanthropic, political or religious organizations, and the sub-organizations are local chapters of the NPOs. The NPOs and their local chapters conduct online and offline fundraising and support various charitable causes. The NPOs and their local chapters can utilize the data warehouse to store donor and constituent data. The data includes personal data as well as transactional data.

The sub-organizations or individuals within the sub-organizations choose whether to share information with other sub-organizations or individuals, what type of information to share and with whom to share. The invention provides various opt-in features by which individual donors, employees or volunteers decide how to participate in the data sharing scheme. The invention preserves the integrity of data by ensuring secrecy of the data and by allowing the employees, volunteers or donors to maintain control over the data.

In one embodiment, the information is housed in the data warehouse maintained by an ASP. The data warehouse includes many virtual data islands, each virtual data island housing data of a multi-level organization. In one embodiment, the data warehouse resides in one database server. In another embodiment, the data is distributed in a cluster or several clusters of databases. The multi-level organizations, e.g., NPOs, as well as their contacts, donors, volunteers, board members, associates, and event participants can access the database server via the Internet.

As described before, the invention is a virtual database for efficiently maintaining data of membership and nonprofit organizations. In one embodiment, the invention efficiently maintains data of multiple organizations by segregating data across the organizations.

Another feature of the invention provides a comprehensive database privilege and masking function for organizations.

In one embodiment, the invention comprises various “islands” that represent data segments within one master database. The invention utilizes these “islands” to segregate data across multiple organizations. Each island represents a different organization with its own organizational structure and privileges.

The invention also segregates data within an organization. For example, an organization can have multiple sub-organizations or chapters. The islands also represent individual chapters within one organization.

In one embodiment, the invention provides a “tree architecture” where “parent organization” represents a higher-level organization and a “child organization” represents a lower-level organizations. The invention allows data from “child organizations” to be rolled-up into the “parent organization.” Data roll-up is the process by which data entered within all child organizations are made available within the associated parent organization.

In one embodiment, the database structure includes a top-tier, master account for the entire organization as well as middle-tiered accounts to represent intermediate organization levels. The lowest tier includes local or field-level accounts where data roll up views are more restricted than for those upper-level accounts. On the other hand, data from all lower level accounts automatically roll-up and are viewable to higher level accounts. In one embodiment, individuals or child organizations can mask certain fields from parent organizations.

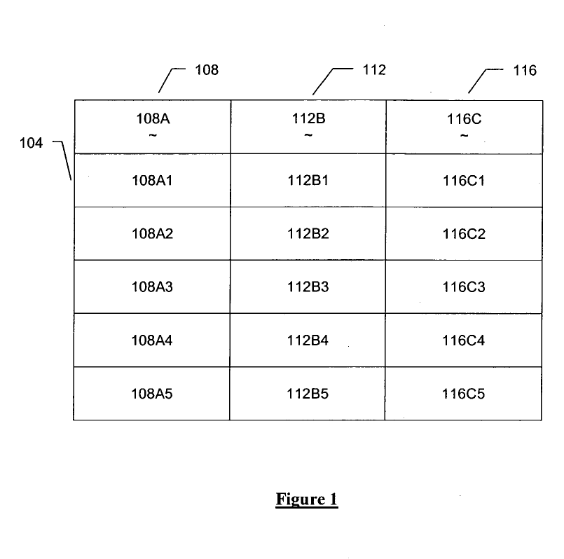

FIG. 1 illustrates a database 104 in accordance with one embodiment of the invention. Database 104 resides in a computer system linked to a network such as the Internet. Database 104 is configured to store data of one or more multi-level organizations.

Database 104 is partitioned into three virtual islands 108, 112 and 116. Each virtual island is configured to store a multi-level organizations' data. Thus, virtual island 108 stores a particular multi-level organization's data. A typical multi-level organization includes a parent organization and one or more chapters or sub-organizations. In one embodiment, the multi-level organization is a nonprofit organization engaged in fundraising.

Each virtual island 108 is further subdivided into one or more sub-islands. For example, virtual island 108 includes a sub-island 108A that stores data of the parent organization of a multi-level organization. Sub-islands 108A1-108A5 each store data of a sub-organization. In one embodiment, the sub-level organization is a chapter of the multi-level organization and is engaged in fundraising.

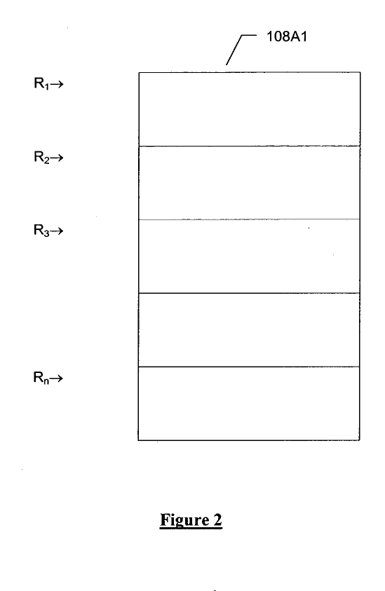

FIG. 2 shows sub-island 108A1 in more detail. Sub-island 108A1 is a database that stores one or more constituent records (CR). For example, sub-island 108A1 can include constituent records of n number of members of the sub-organization. Sub-island 108A1 includes n number of records, R1-Rn, each record retaining data of a particular member.

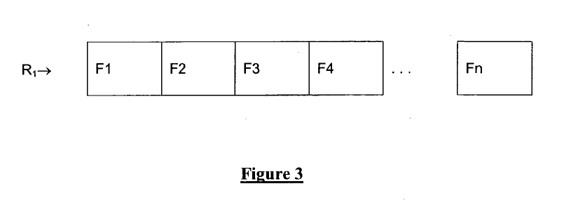

FIG. 3 illustrates a record R1 that retains information about a particular member of the sub-organization. R1 is subdivided into four fields F1-F4. For example, F1 may hold the name of the member, F2 may hold the address of the member, F3 may hold the telephone number of the member and F4 may hold donation information of the member.

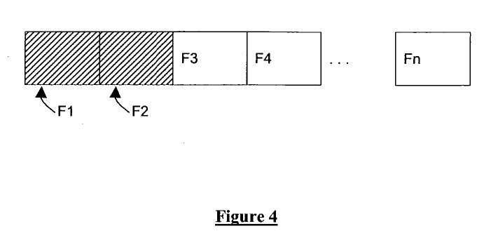

As described before, the invention allows a member, employee or volunteer to mask selected fields if the member does not wish to share certain information. For example, the donor, member, employee or volunteer may not wish to disclose the name and address. In that case, the member can mask the fields F1 and F2 as shown in FIG. 4. When masked, the information in the masked fields is not shared with multi-level organizations and other sub-organizations.

The invention allows the members to update or edit their information in the records. In one embodiment, a record can be associated in a plurality of sub-organizations across a plurality of multi-level organizations. In one embodiment, a record includes one or more standard fields and one or more special fields. The standard fields are shared with other sub-organizations and multi-level organizations. The special fields are not shared if they are masked. An update of a field in a record automatically updates the same fields in parent, child or other sub-organizations.

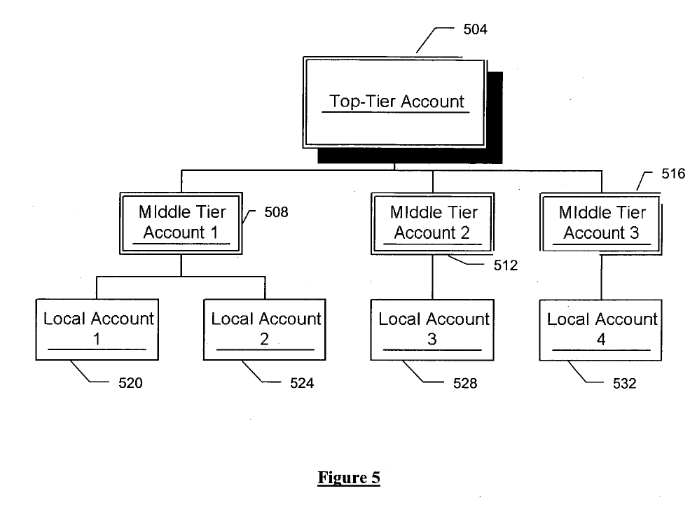

FIG. 5 illustrates another embodiment of the invention. In FIG. 5, a nonprofit organization (NPO) includes a top tier account 504, middle tier accounts 508, 512 and 516. Middle tier account 508 further includes local accounts 520 and 524, middle tier account 512 includes local account 528, and middle tier account 516 includes local account 532. The top tier account 504 can be considered a national organization or headquarter of an NPO. The middle tier accounts can be considered as regional chapters of the NPO. The local accounts can be considered as local chapters of the NPO.

The national organization and its regional and local chapters can be engaged in fundraising activities or other activities. The national organization and the chapters typically each have many members. The members can be donors, supporters or volunteers. It is essential for the NPO and the chapters to maintain membership information. The membership information includes member names, contact information, donation information and other information. As will be explained below, the invention can be utilized to efficiently store and retain data of the NPO and its various chapters.

In FIG. 5, the data of each account can be stored in sub-islands illustrated in FIGS. 1 and 2. For example, the top tier account 504 can be retained in the sub-island 108A. The middle tier account 520 can be retained in sub-island 108A1, and local account 520 can be retained in sub-island 108A2.

In one embodiment, the data within Local Account 1 is available in Middle Tier Account 1 and Top-tier Account, but not in Middle Tier Account 2, Middle Tier Account 3, Local Account 2, Local Account 3, and Local Account 4. Thus, the invention allows local accounts within a large organization to have the ability to mask data of their own contact records. By masking data, local accounts restrict the information that is available within associated parent accounts that have access to the local account data. Using a simple administrative toggle, the each account below the top-tier account (includes all middle tier and local account levels) can activate or deactivate sharing of contact data with associated parent accounts. The administrative tool used to toggle the data sharing is described below.

[image]

[image]

Toggle for Data Sharing (Do Not Share)

In one embodiment, a local account or a member will be able to click “Do Not Share Information” to deactivate the sharing of data. When an account “deactivates” sharing of data, the parent accounts have limited access to data in those records or those fields. The contact record is effectively masked, thus hiding certain information from the parent accounts. The local account or the member can also reactivate sharing of the data, by clicking on “Share Information.”.

[image]

Toggle for Data Sharing (Do Not Share)

In one embodiment, when sharing is activated, the parent organizations data roll-up capabilities include:
Full access to standard contact data (such as name, address, phone number)
Full access to transaction data (such as donations, registrations, sponsorships)
Full access to activity data (such as email receipts, email subscriptions, phone calls)

When sharing is deactivated, the parent organization data roll-up can be limited to:
Limited access to standard contact data (such as name, address, phone number)
Full access to transaction data (such as donations, registrations, sponsorships)
Full access to activity data (such as email receipts, email subscriptions, phone calls)
   The standard contact data that is restricted includes: email address, address 1, address 2, and phone numbers (fax, home, business, mobile). Reports showing these restricted data are masked with asterisks, as shown below. [image]
   Data Masking on Roll-Up Report

As described above, Dylan Bona represents a contact record within an account which is set up to share data. The other contacts (e.g., Mike Beard) are included within accounts which are not set up to share data. The following fields are therefore masked for those individuals: address 1, address 2, phone and email.

By restricting access to selected fields, the local account can restrict the ability for the parent organization to use the information to contact the supporter themselves. This is an important feature since local organizations often like to control access to their donors to limit solicitations from the parent organization.

As described before, the invention is a database segmented into data islands. The invention utilizes two tables, an account table and a supporter table, to manage the data islands. The account table includes information for each child and parent account within the master database. Each row within the table includes a unique account. The relationship amongst the accounts are defined by columns in the table that indicate under which organization the account belongs and at which level within the organization the account resides. The account information stored in this table includes whether or not the account is set up to share data to other parent accounts. Note that sharing is only available to parent accounts directly above the child account within the same organization. If the parent resides in another tree of the organization, or in another organization altogether, the data will not be shared at all.

The supporter table includes information for each contact record. The information includes the profile data for that contact record and the account with which the contact record is associated. When a user of a parent account runs a roll-up report, the user has the ability to choose from the accounts below them (associated child accounts within their organization tree). An account selection tool is described below.

[image]

Roll-Up Report Account Selection for Parent Account

After the user selects the child accounts, the reports will roll-up data from those child accounts as shown above. Each contact record that is included in the report is pulled from the supporter table. As the report is generated, the programming code runs a check for that supporter and pulls the account ID that represents the account to which the contact record is associated. That account ID is linked to the account table. When the matching account is found on the account table, the programming code checks to see if that account has been set up to share data or not. This information is included in a table and is binary (yes or no). If the account is found to share data, then the report will show all of the data without the above described restrictions. If the account is found to NOT share data, then data for certain restricted fields are masked with asterisks. In one embodiment, the report may include a summary of the data, but not individual data.

Privileges to data can be granted in three ways:
Parent organization assignment—All parent organizations can grant access to contact records to child accounts within their organization branch.
Local account transfer—A local account can grant access to their contact record to other local accounts.
Contact record opt-in—The contact can opt-in to another local account through a transaction or activity thus adding him/her to that account's database. 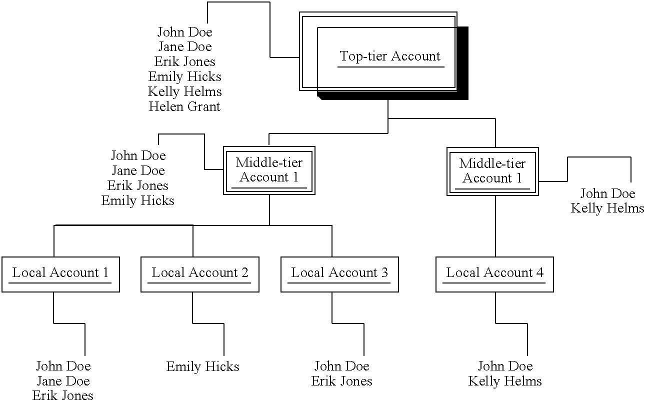
   Organization Database Example

In the above example, the same John Doe is part of three Local Account accounts, and all middle-tier and top-tier accounts associated with those Local Account accounts.

Standard Profile fields are considered shared and therefore can be viewed across all accounts in which a contact record is included. For instance, If John enters his address in Local Account 1, his address is automatically available in Middle-tier 1 and the Top-tier accounts. When a contact record joins another child account, standard fields are made available in that new account. For instance, when John donated to support Local Account 3, his address information added in Local Account 1 will be available for Local Account 3.

Updates to Standard fields made in one account, update the same fields in the other accounts. So if a staff person updates the account in Local Account 3 as a result of a phone call from John, Local Account 1's John Doe record is automatically updated.

All upper tier accounts have access to view/edit data from all lower accounts. Updates made by an upper account to standard fields update all records as noted above. Transaction data for a contact is only available within that account and any parent accounts. For instance, the donation made to Local Account 3 for John, cannot be viewed by Local Account 1 personnel.

Each Child account can set up their own set up custom fields for each record. Data in these custom fields are only available with that child account and parents to that child account. For instance, if Local Account 3 asks whether or not John smokes, that information would not be available to Local Account 1, but will be available to Local Account 3, Middle-tier 1, and the Top-Tier account.

The database sharing reducing duplication of effort where data collected within one group of organization can be shared with others in the same organization without data transfer or additional data entry. This feature also simplifies the management of the profile data for a contact record improving the reliability and accuracy of the data. The feature does not compromise the security of information so that private data from one local account, is not available in other local accounts.

Thus, it is apparent that there has been provided, in accordance with the present invention, a system and method for database privilege and masking for membership and association organizations and other organizations including multi-level organizations. Although the preferred embodiments have been described, it should be understood that various changes, substitutions, and alterations can be made herein without departing from the scope of the present invention. Furthermore, it should be noted that the present invention may be implemented using virtually any computer system and virtually any available programming language. Other examples of changes, substitutions, and alterations are readily ascertainable by one skilled in the art and could be made without departing from the spirit and scope of the present invention as defined by the following claims.

1. A database in a computer system linked to a network and configured to store one or more organizations' data, each organization having one or more sub-organizations, the computer system having one or more processors and one or more storage devices coupled to the processor for storing data, comprising:
one or more virtual data islands partitioned inside the database, each virtual data island storing data of an organization;
each virtual data islands further partitioned into one or more sub-islands, wherein each sub-island storing data for a sub-organization;
one or more constituent records (CR) in each sub-island, each including one or more fields with data;
wherein a sub-organization can share data from selected fields with organizations and other sub-organizations.

2. The database according to claim 1, further comprising a masking means allowing the sub-organization to mask one or more fields in one or more CR, wherein data in the masked fields are not shared with the organizations and other sub-organizations.

3. The database according to claim 1, wherein the organization is a nonprofit organization engaged in fundraising.

4. The database according to claim 1, wherein the sub-organization is a chapter of the organization and is engaged in fundraising.

5. The database according to claim 1, wherein the CR includes donor information.

6. The database according to claim 1, wherein a field in the CR includes donor names.

7. The database according to claim 1, wherein a field in the CR includes donor contact information.

8. The database according to claim 1, wherein a field in the CR includes the amount of money donated by the donors.

9. The database according to claim 1, wherein data from fields that are not masked are automatically provided to the organization.

10. The database according to claim 5, further comprising means for allowing individual donors to mask selected fields.

11. The database according to claim 5, further comprising means for allowing volunteers to mask selected fields.

12. The database according to claim 5, further comprising means for allowing organizations to mask selected fields.

13. The database according to claim 5, further comprising means for allowing sub-organizations to mask selected fields.

14. The database according to claim 1, wherein a CR can be associated in a plurality of sub-organizations in a plurality of organizations.

15. The database according to claim 1, wherein a CR includes one or more standard fields and one or more special fields.

16. The database according to claim 15, wherein standard fields are shared with other sub-organizations and multi-level organizations.

17. The database according to claim 15, wherein the special fields are not shared if they are masked, and wherein the special fields are shared if they are masked.

18. The database according to claim 15, wherein an update of a field in a CR automatically updates the same fields in other sub-organizations.

19. The database according to claim 1, wherein the network is the Internet.

20. The database according to claim 1, wherein the network is a wide area network.

21. The database according to claim 1, wherein the organization is a nonprofit organization (NPO).

22. The database according to claim 1, wherein the organization is a charitable organization.

23. A method for storing one or more organizations' data in a database in a computer system linked to a network, each organization having one or more sub-organizations, the computer system having one or more processors and one or more storage devices coupled to the processor for storing data, comprising the steps of:
creating one or more virtual data islands partitioned inside the database, each virtual data island storing data of an organization;
partitioning each virtual data islands into one or more sub-islands, wherein each sub-island storing data for a sub-organization;
creating one or more constituent records (CR) in each sub-island, each CR including one or more fields with data;
wherein a sub-organization can share data from selected fields with organizations and other sub-organizations.

24. The method according to claim 23, further comprising the step of masking one or more fields in the CR, wherein data in the masked fields are not shared with the organizations and other sub-organizations.

25. The method according to claim 24, wherein data from fields that are not masked are automatically shared with the organizations.

26. The method according to claim 24, wherein the organization is a nonprofit organization engaged in fundraising.

27. The method according to claim 24, wherein the sub-organization is a chapter of the organization and is engaged in fundraising.

28. The method according to claim 24, wherein the CR includes donor information.

29. method according to claim 24, wherein a field in the CR includes donor names.

30. The method according to claim 24, wherein a field in the CR includes donor contact information.

31. The method according to claim 24, wherein a field in the CR includes the amount of money donated by the donors.

32. A computer program product including a program code embodied in a storage medium for carrying out the method steps for storing one or more organizations' data in a database in a computer system linked to a network, each organization having one or more sub-organizations, the computer system having one or more processors and one or more storage devices coupled to the processor for storing data, the method comprising the steps of:
creating one or more virtual data islands partitioned inside the database, each virtual data island storing data of an organization;
partitioning each virtual data islands into one or more sub-islands, wherein each sub-island storing data for a sub-organization;
creating one or more constituent records (CR) in each sub-island, each CR including one or more fields with data;
wherein a sub-organization can share data from selected fields with organizations and other sub-organizations.
